(19) United States
(12) Patent Application Publication
(10) Pub. No.: US 2007/0057934 A1
(43) Pub. Date: Mar. 15, 2007

(54) VOLTAGE-CONVERTING CIRCUIT FOR ADJUSTING OUTPUT VOLTAGES

(76) Inventors: Xuan-Ce Jia, Suzhou City, Jiansu Province (CN); Chiao-Chung Huang, Hsin-Chu Hsien (TW); Xin-Lu Yang, Suzhou City, Jiansu Province (CN)

Correspondence Address: NORTH AMERICA INTELLECTUAL PROPERTY CORPORATION, P.O. BOX 506, MERRIFIELD, VA, 22116, US

(21) Appl. No.: 11/164,661

(22) Filed: Dec. 1, 2005

(30) Foreign Application Priority Data
Sep. 13, 2005 (TW) 094131520

(51) Int. Cl. G09G 5/00

(52) U.S. Cl. 345/211

(57) ABSTRACT

A voltage converter includes a pulse width modulation circuit and a feedback circuit. The pulse width modulation circuit provides output voltages in the form of pulses and changes the value and frequency of the output voltages by changing the width, frequency and distribution of the pulses. The feedback circuit includes a resistor string formed by a plurality of resistors. One end of the resistor string is coupled to a variable voltage source. An input end of the pulse width modulation circuit is coupled to two adjacent resistors of the resistor string. The voltage converter adjusts the output voltages by adjusting the variable voltage sources.

### BACKGROUND OF THE INVENTION

1. Field of the Invention

The present invention relates to a voltage-converting circuit, and more particularly, to a voltage-converting circuit capable of adjusting output voltages.

2. Description of the Prior Art

Displays have become more and more common in modern society. With rapid development of technology, the quality of displays also increases and there are various types of displays available in the consumer market. Liquid crystal displays (LCDs) are characterized by light weight, low power consumption, and low radiation, and are therefore widely used in many mobile products, such as notebook computers and personal digital assistants (PDAs), etc. In addition, LCD panels and LCD televisions have gradually replaced traditional cathode ray tube (CRT) panels and televisions in household application.

A thin film transistor liquid crystal display (TFT LCD) is a planar display which uses a TFT manufactured in polysilicon processes for controlling each pixel. TFT LCDs have small sizes, light weight, high reaction rate, low power consumption, high contrast, wide viewing angle, low radiation and a built-in driving circuit. Due to these advantages, TFT LCDs find more and more applications in consumer and data electronic products and the development of large-scaled TFT LCDs is the current trend.

The operations of TFT LCDs require several driving voltages, such as an analog supply voltage (AVDD), a gate turn-on voltage (VGH), or a gate turn-off voltage (VGL), etc. FIG. 1 illustrates a diagram of a driving circuit 10 for use in a TFT LCD. The driving circuit 10, including a pulse width modulation (PWM) circuit 12 and a feedback circuit 14, can convert an input voltage Vi into an output voltage Vo required for operating the TFT LCD. The pulse width modulation circuit 12 provides the output voltage Vo in the form of pulses and changes the magnitude and frequencies of the output voltage Vo by changing the width, the frequencies and the distribution of the pulses. The feedback circuit 14 generates a reference voltage Vref by voltage-dividing the output voltage Vo using resistors R1 and R2, and then sends the reference voltage Vref back to the pulse width modulation circuit 12 for stabilizing the output voltage Vo. In the prior art driving circuit 10, the magnitude of the output voltage is fixed at a constant value that can be represented by the following formula:
V0=(R1+R2)*Vref/R2

FIG. 2 illustrates a functional block of a prior art voltage-converting module 20. The voltage-converting module 20, based on the structure of the driving circuit 10, can convert input voltages Vi1-Vim into output voltages Vo1-Von required for operating a TFT LCD. The number of the input and output voltages m and n depend on different types of TFT LCDs. Regardless of the values of m and n, the voltage-converting module 20 designed for a certain TFT LCD has input voltages of constant magnitude and the value of corresponding driving voltages generated from the fixed input voltages cannot be changed.

Due to variance in each manufacturing procedure, the same type of TFT LCDs produced in the same process flow in the same fab can have different characteristics. Driving these TFT LCDs with the same driving voltages cannot achieve the best performance for all TFT LCDs. Also, when a prior art TFT LCD suffers from certain defects and requires analysis, such as testing or analyzing center mura of the TFT LCD, the prior art TFT LCD fails to provide flexible adjustments on the driving voltages when performing analysis.

### SUMMARY OF THE INVENTION

It is therefore a primary objective of the claimed invention to provide a voltage-converting circuit capable of adjusting output voltages in order to solve the problems of the prior art.

The claimed invention provides a voltage-converting circuit for adjusting output voltages comprising a pulse width modulation circuit for providing output voltages in the form of pulses and for changing the magnitude and frequencies of the output voltages by changing the width, the frequencies and the distribution of the pulses, the pulse width modulation circuit having an input end; and a feedback circuit comprising a resistor string formed by a plurality of resistors coupled in series, and a first variable voltage source coupled to a first end of the resistor string; wherein the input end of the pulse width modulation circuit is coupled between two adjacent resistors of the resistor string.

The claimed invention further provides an integrated circuit for adjusting output voltages comprising a voltage-converting circuit comprising a pulse width modulation circuit for providing output voltages in the form of pulses and for changing magnitude and frequencies of the output voltages by changing the width, the frequencies and the distribution of the pulses, and a feedback circuit comprising a resistor string formed by a plurality of resistors coupled in series, and a first variable voltage source coupled to a first end of the resistor string; wherein the input end of the pulse width modulation circuit is coupled between two adjacent resistors of the resistor string; an input voltage source coupled to the input end of the pulse width modulation circuit; and a load coupled to an output end of the pulse width modulation circuit.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a prior art TFT LCD driving circuit.

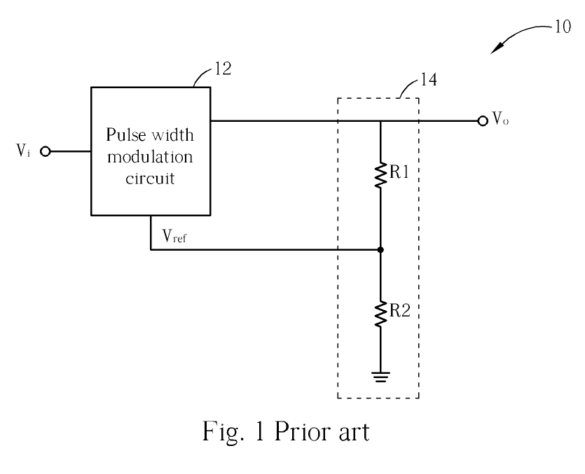

FIG. 2 is a functional block of a prior art voltage-converting module.

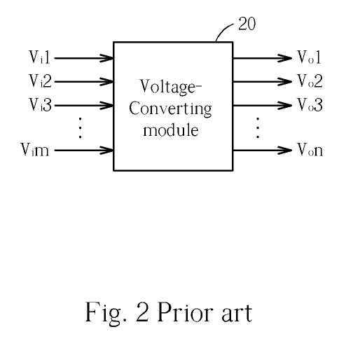

FIG. 3 is a diagram of a TFT LCD driving circuit according to a first embodiment of the present invention.

FIG. 4 is a diagram of a boost converter used in the TFT LCD driving circuit of FIG. 3.

FIG. 5 is a diagram of a buck converter used in the TFT LCD driving circuit of FIG. 3.

FIG. 6 is a diagram of a TFT LCD driving circuit according to a second embodiment of the present invention.

FIG. 7 is a diagram of a TFT LCD driving circuit according to a third embodiment of the present invention.

FIG. 8 is a functional block of a voltage-converting module according to the present invention.

### DETAILED DESCRIPTION

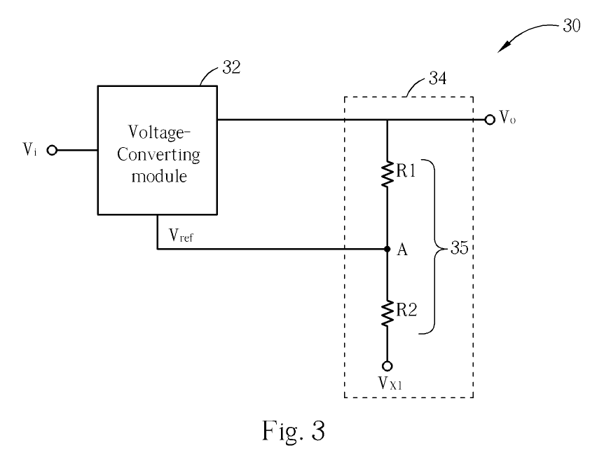

FIG. 3 illustrates a driving circuit 30 of a TFT LCD according to a first embodiment of the present invention. The driving circuit 30, including a voltage-converting module 32 and a feedback circuit 34, can convert an input voltage Vi into an output voltage Vo required for operating the TFT LCD. In the first embodiment of the present invention, a resistor string 35 of the feedback circuit 34 includes resistors R1 and R2 coupled in series. One end of the resistor string 35 is coupled to an output end of the driving circuit 30, and the other end of the resistor string 35 is coupled to a variable voltage source Vx1. The feedback circuit 34 generates a reference voltage Vref at a node A of the driving circuit 30 by voltage-dividing the output voltage Vo using resistors R1 and R2, and then sends the reference voltage Vref back to the voltage-converting module 32. The voltage-converting module 32 adjusts the output voltage Vo based on the reference voltage Vref and thereby stabilizes the output voltage Vo. In the driving circuit 30 of the present invention, the value of the output voltage Vo can be represented by the following formula:

$$V 0 = \frac{( R 1 + R 2 )}{R 2} \times ( Vref - Vx 1 ) + Vx 1$$

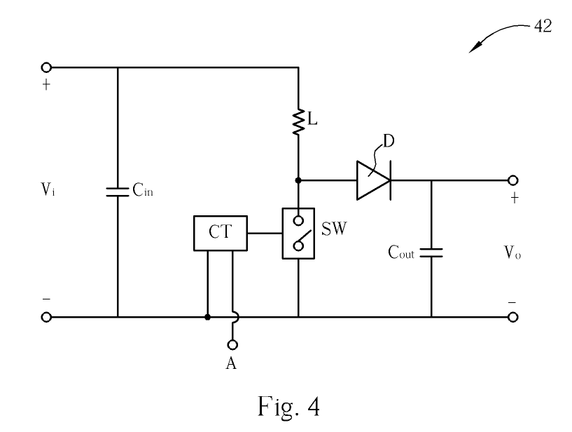

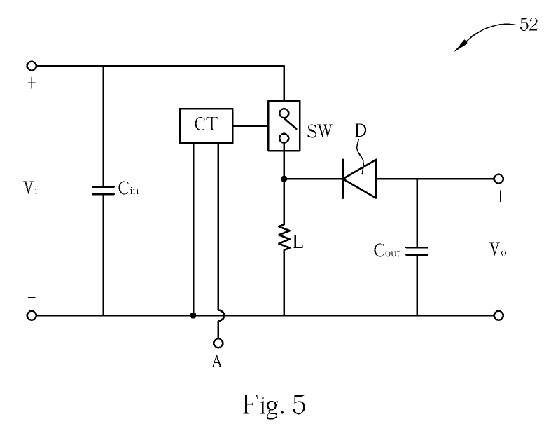

The voltage-converting module 32 can include a boost converter 42 or a buck converter 52, illustrated in FIG. 4 and FIG. 5 respectively. In FIG. 4 and FIG. 5, Cin and Cout represent buffer capacitors for stabilizing the input voltage Vi and the output voltage Vo, respectively. A switching device SW can be a metal oxide semiconductor field effect transistor (MOSFET), a bipolar junction transistor (BJT), or other devices capable of functioning as switches. A diode D can be a Schottky diode, or other devices capable of functioning as switches. The switching device SW and the diode D control current paths in the voltage-converting module 32. Each of the boost converter 42 and the buck converter 52 includes an inductor L coupled between respective input and output ends for providing input current. A control circuit CT can be a pulse width modulation circuit which provides the output voltage Vo in the form of pulses and changes the magnitude and frequencies of the output voltage Vo by changing the width, the frequencies and the distribution of the pulses. The boost converter 42 and the buck converter 52 are merely exemplary embodiments of the voltage-converting module 32, and other types voltage-converting circuits can also be adopted for the voltage-converting module 32 of the present invention.

Since the resistor string 35 is coupled between the output end of the driving circuit 30 and the variable voltage source Vx1, TFT LCDs using the driving circuit 30 of the present invention can adjust the value of the output voltage Vo by adjusting the variable voltage source Vx1. Based on different product characteristics, the driving voltages can be adjusted for better display quality. In addition, when a TFT LCD suffers from certain defects and requires center mura tests or analysis, the driving circuit 30 can provide adjustable and flexible driving voltages by adjusting the variable voltage source Vx1.

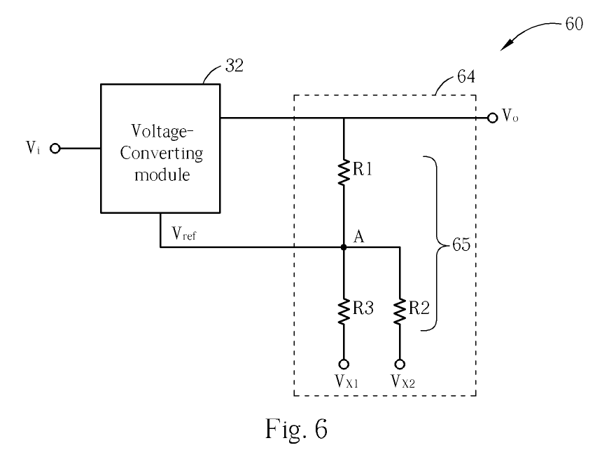

FIG. 6 illustrates a driving circuit 60 of a TFT LCD according to a second embodiment of the present invention. The driving circuit 60 differs from the driving circuit 30 in that the driving circuit 60 includes a feedback circuit 64. In the second embodiment of the present invention, a resistor string 65 of the feedback circuit 64 includes resistors R1, R2 and R3. One end of each of the resistors R1, R2 and R3 is coupled to an output end of the driving circuit 60, a variable voltage source Vx2, and a variable voltage source Vx1, respectively. The other ends of the resistors R1, R2 and R3 are coupled to a node A of the driving circuit 60. The feedback circuit 64 generates a reference voltage Vref at the node A of the driving circuit 60 by voltage-dividing the output voltage Vo using resistors R1, R2 and R3, and then sends the reference voltage Vref back to the voltage-converting module 32. The voltage-converting module 32 adjusts the output voltage Vo based on the reference voltage Vref and thereby stabilizes the output voltage Vo. In the driving circuit 60 of the present invention, the value of the output voltage Vo can be adjusted by adjusting the variable voltage sources Vx1 and Vx2, and can be represented by the following formula:

$$V 0 = \frac{( R 1 R 2 + R 2 R 3 + R 1 R 3 ) Vref - R 1 R 2 Vx 1 - R 1 R 3 Vx 2}{R 2 R 3}$$

In the driving circuit 60 of the present invention, the variable voltage sources Vx2 can also be a constant voltage source. If the variable voltage sources Vx2 has ground level, the value of the output voltage Vo can be adjusted by adjusting the variable voltage sources Vx1, and can be represented by the following formula:

$$V 0 = \frac{( R 1 R 2 + R 2 R 3 + R 1 R 3 ) Vref - R 1 R 2 Vx 1}{R 2 R 3}$$

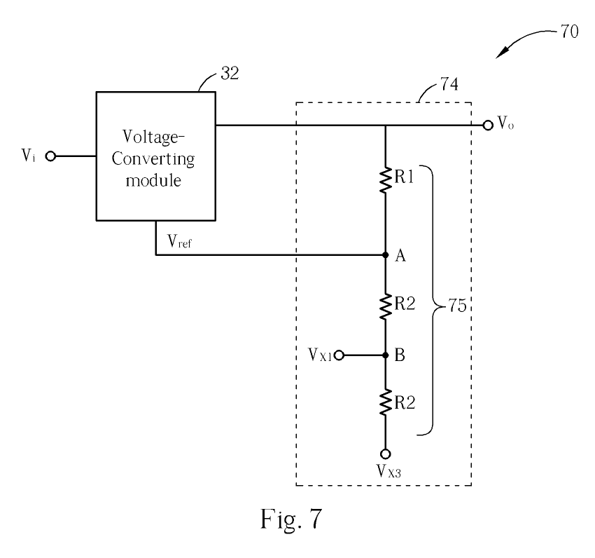

FIG. 7 illustrates a driving circuit 70 of a TFT LCD according to a third embodiment of the present invention. The driving circuit 70 differs from the driving circuit 30 in that the driving circuit 70 includes a feedback circuit 74. In the third embodiment of the present invention, a resistor string 75 of the feedback circuit 74 includes resistors R1, R2 and R3 coupled in series. The resistor string 75 is coupled between an output end of the driving circuit 70 and a variable voltage source Vx3. A variable voltage source Vx1 is coupled to a node B between the resistors R2 and R3. The feedback circuit 74 generates a reference voltage Vref at a node A of the driving circuit 70 by voltage-dividing the output voltage Vo using resistors R1, R2 and R3, and then sends the reference voltage Vref back to the voltage-converting module 32. The voltage-converting module 32 adjusts the output voltage Vo based on the reference voltage Vref and thereby stabilizes the output voltage Vo. In the driving circuit 70 of the present invention, the value of the output voltage Vo can be adjusted by adjusting the variable voltage sources Vx1 and Vx3, and can be represented by the following formula:

$$V 0 = \frac{( R 1 + R 2 + R 3 ) \times ( Vref - Vx 1 )}{R 2} + Vx 3$$

In the driving circuit 70 of the present invention, the variable voltage sources Vx1 can also be a constant voltage source. If the variable voltage sources Vx1 has ground level, the value of the output voltage Vo can be adjusted by adjusting the variable voltage sources Vx3, and can be represented by the following formula:

$$V 0 = \frac{( R 1 + R 2 + R 3 ) Vref}{R 2} + Vx 3$$

In the first through third embodiments of the present invention, the variable sources Vx1-Vx3 can be adjusted externally or internally. When the variable sources Vx1-Vx3 are adjusted externally, a tester or an external system provides adjusting signals using a separate input terminal disposed on a circuit board of the TFT LCD, or using an existing terminal on the circuit board of the TFT LCD, such as a differential signal terminal or an aging mode terminal. When the variable sources Vx1-Vx3 are adjusted internally, data corresponding to the variable sources Vx1-Vx3 is stored in non-volatile random access memory of the TFT LCD, and is adjusted using a digital-to-analog converter. The non-volatile random access memory of the TFT LCD can be edited using external circuits and can be integrated with the digital-to-analog converter into the same integrated circuit, which can further be integrated with the application specific integrated circuits (ASICs) or other circuits of the TFT LCD.

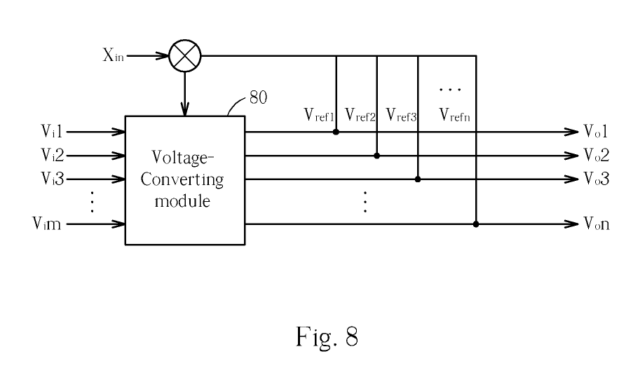

FIG. 8 illustrates a functional block of a voltage-converting module 80 according to the present invention. The voltage-converting module 80, which can adopt the driving circuit 30, 60 or 70, can convert input voltages Vi1-Vim into output voltages Vo1-Von required for operating a TFT LCD. Based on a control signal Xin, reference voltages Vref1-Vrefn are sent to the voltage-converting module 80 for stabilizing output voltages. The number of the input and output voltages m and n depend on different types of TFT LCDs.

The driving voltages generated in the prior art TFT LCDs are fixed at constant values, and cannot be adjusted for different product characteristics or during tests and analysis. Compared to the prior art, the present invention adjusts the value of the driving voltage by adjusting the variable voltage sources Vx1-Vx3. Therefore, the driving voltages can be adjusted for better display quality based on different product characteristics. In addition, when a TFT LCD suffers from certain defects and requires center mura tests or analysis, the present invention can provide flexible adjustment of driving voltages, which can improve the efficiency of failure analysis.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A voltage-converting circuit for adjusting output voltages, the voltage-converting circuit comprising:
a pulse width modulation circuit for providing output voltages in the form of pulses and for changing the magnitude and frequencies of the output voltages by changing the width, the frequencies and the distribution of the pulses, the pulse width modulation circuit having an input end;
a feedback circuit comprising a resistor string formed by a plurality of resistors coupled in series; and
a first variable voltage source, coupled to a first end of the resistor string;
wherein the input end of the pulse width modulation circuit is coupled between two adjacent resistors of the resistor string.

2. The voltage-converting circuit of claim 1, wherein the feedback circuit further comprises a resistor, a first end of the resistor coupled between two adjacent resistors of the resistor string, and a second end of the resistor coupled to a voltage source.

3. The voltage-converting circuit of claim 1, wherein the feedback circuit further comprises:
a resistor having a first end coupled between two adjacent resistors of the resistor string, and
a second variable voltage source coupled to a second end of the resistor.

4. The voltage-converting circuit of claim 2, wherein the second end of the resistor is coupled to ground.

5. The voltage-converting circuit of claim 1, wherein the feedback circuit further comprises a resistor having a first end coupled between the first end of the resistor string and the first variable voltage source, and a second end coupled to a second variable voltage source.

6. An integrated circuit for adjusting output voltages, the integrated circuit comprising:
a voltage-converting circuit comprising:
a pulse width modulation circuit for providing output voltages in the form of pulses and for changing magnitude and frequencies of the output voltages by changing the width, the frequencies and the distribution of the pulses, the pulse width modulation circuit having an input end and an output end;
a feedback circuit comprising a resistor string formed by a plurality of resistors coupled in series; and
a first variable voltage source coupled to a first end of the resistor string;
wherein the input end of the pulse width modulation circuit is coupled between two adjacent resistors of the resistor string;
an input voltage source coupled to the input end of the pulse width modulation circuit; and
a load coupled to an output end of the pulse width modulation circuit.

7. The integrated circuit of claim 6, wherein the feedback circuit further comprises a resistor having a first end coupled between two adjacent resistors of the resistor string, and a second end coupled to a voltage source.

8. The integrated circuit of claim 6, wherein the feedback circuit further comprises:
a resistor having a first end coupled between two adjacent resistors of the resistor string, and
a second variable voltage source coupled to a second end of the resistor.

9. The integrated circuit of claim 7, wherein the second end of the resistor is coupled to ground.

10. The integrated circuit of claim 6, wherein the voltage-converting circuit further comprises a resistor having a first end coupled between the first end of the resistor string and the first variable voltage source, and a second end o coupled to a second variable voltage source.

11. The integrated circuit of claim 6, further comprising an inductor coupled between the input and output ends of the voltage-converting circuit for supplying an input current.

12. The integrated circuit of claim 6, further comprising a switching device coupled between the input and output ends of the voltage-converting circuit, for providing a current path through which current flows from the input end to the output end of the voltage-converting circuit when the switching device is turned on.

13. The integrated circuit of claim 12, wherein the switching device comprises a Schottky diode.

14. The integrated circuit of claim 6, further comprising a buffer circuit coupled to the output end of the voltage-converting circuit for stabilizing output voltages of the voltage-converting circuit.

15. The integrated circuit of claim 10, wherein the buffer circuit includes a capacitor.
